(19) United States
(12) Patent Application Publication
(10) Pub. No.: US 2026/0166891 A1
(43) Pub. Date: Jun. 18, 2026

(54) METHOD FOR PRINTING ON A SURFACE OF AN ELECTRONIC CHIP CARD

(71) Applicant: IDEMIA FRANCE, Courbevoie (FR)

(72) Inventor: Chloé MAHÉ, Courbevoie (FR)

(73) Assignee: IDEMIA FRANCE, Courbevoie (FR)

(21) Appl. No.: 19/418,023

(22) Filed: Dec. 12, 2025

(30) Foreign Application Priority Data
Dec. 13, 2024 (FR) FR2414135

(51) Int. Cl. B41J 11/00; B41J 2/21; B41J 3/407

(52) U.S. Cl. CPC B41J 11/00214; B41J 2/2114; B41J 3/407; B41J 2/2103

(57) ABSTRACT

A method for inkjet printing a pattern on a surface of an electronic chip card, that includes a step of printing by means of inkjet printheads to form a colour pattern on the surface of the card, a step of printing a varnish, by means of a printhead, on said surface of the card, a step of implementing a rest period, and a step of polymerizing the ink and the varnish by applying ultraviolet radiation to the surface of the card.

### TECHNICAL FIELD OF THE INVENTION

The present invention relates to a method for inkjet printing a pattern on a surface of an electronic chip card.

It also relates to an electronic chip card comprising a pattern printed according to the printing method according to the invention.

### PRIOR ART

The present invention is applicable in the field of electronic chip cards, such as bank cards, access cards, etc. It relates both to chip cards which use contacts to communicate and to those which communicate via radio frequency waves.

Such an electronic chip card usually comprises a pattern printed on at least one of its opposite faces, forming decoration and making it possible to identify, for example, the provider or the location of use of the card.

A method for manufacturing a printed chip card with a visual relief effect is known from document U.S. Pat. No. 7,455,235 B2. This method comprises a step of applying a metallic ink to a surface of a chip card, followed by partially coating this metallic ink with a varnish, thus creating an inscription having a three-dimensional appearance. The metallic ink and the varnish are applied to a surface of the chip card by using a screen printing method. The varnish, applied in a viscous state, is polymerized using ultraviolet radiation.

The assembly is then covered with an overlay layer which, when it is laminated, retains the shiny metallic parts and transforms the varnish into a dull surface, contributing to the relief effect.

However, it is often desired for the electronic chip card to be able to be personalized depending on the use, the holder and the provider of the card. Thus, for a bank or payment card, printing a personalized logo may be desired by the issuing bank. For an access card to a secure building, an image or text may be printed at the request of the customer in order to make it easier to recognize the access card and its use.

In order to be able to meet these needs for personalizing a printed pattern, it is known to use inkjet printing techniques which make it possible, based on a digital file containing the data of the pattern to be printed, to produce a specific pattern on the surface of a digital chip card by using a printer having inkjet printheads.

This is thus referred to as Drop on Demand or DoD.

Inkjet printing makes it possible to print personalized patterns unlike mass printing techniques of the offset or screen printing type.

Nevertheless, inkjet printing has the drawback of creating a pattern on the surface of the electronic chip card which is more or less shiny depending on the printed colour: the light colour parts have a duller appearance than the dark colour parts which shine more.

Furthermore, the printed surface of the electronic chip card has a non-uniform feel, the amount of ink deposited to print the dark colour portions of the pattern being greater than that deposited to print the light colour portions of the pattern.

Consequently, the dark colour portions are thicker and form an excess thickness with respect to the light colour portions.

For example, a deviation in thickness between the highest point and the lowest point (in a direction perpendicular to the surface of the card) of the order of 0.020 μm, possibly reaching 0.025 μm, may be observed.

### SUMMARY OF THE INVENTION

The present invention aims to overcome all or some of the drawbacks of the prior art mentioned above.

To this end, the invention is aimed at a method for inkjet printing a pattern on a surface of an electronic chip card.

According to the invention, the printing method comprises the following steps:
printing by means of inkjet printheads to form a colour pattern on the surface of the card;
printing a varnish, by means of a printhead, on said surface of the card;
implementing a rest period; and
polymerizing the ink and the varnish by applying ultraviolet radiation to the surface of the card.

Printing varnish on the surface of the card makes it possible to at least partially conceal the reliefs created on the surface of the card by inkjet printing.

The rest period allows the varnish to flow over the surface of the card towards the holes or interstices created within the printed colour pattern and thus make the surface of the card uniform.

In practice, the colour pattern comprises at least two distinct colour portions.

The varnish thus fills the interstices created between the distinct colour portions, that is to say between the printing areas of lighter colour ink and the adjacent printing areas of darker colour ink. The varnish also spreads over the printing areas of lighter colour, which are not as thick as the printing areas of darker colour.

In practice, the rest period is at least equal to 0.5 seconds, and preferably greater than 0.8 seconds.

According to one advantageous feature, in the step of printing a varnish, a uniformly distributed amount is applied by the printhead to the surface of the card.

The coat of varnish thus applied makes it possible to create a uniform deposit over the entire surface of the card before the varnish flows to fill the interstices between the printed areas of different colours.

In practice, in the step of printing a varnish, the printhead is controlled by a printing driver on the basis of a selected level value on a scale of levels of between 0 and 255 respectively corresponding to an amount of varnish deposited by said printhead for each printed pixel, the amount of varnish deposited varying linearly between 0 drops at level 0 and 4 drops at level 255 and the selected level value being at least equal to 155, and preferably greater than 175.

The Applicant found that the level value of at least equal to 175 was well suited to obtaining a sufficient amount of varnish for compensating for the reliefs created on the surface of the card by inkjet printing a pattern.

According to one advantageous feature, the printing method further comprises a step of pre-polymerizing the ink before said step of printing a varnish, by applying ultraviolet radiation to the colour pattern formed on the surface of the card.

The pre-polymerization step prevents the ink from spreading over the surface of the card and makes it possible to limit the mixing of the colours in order to obtain a sharp edge of the images or text of the printed colour pattern.

In practice, the power of the ultraviolet radiation of the step of pre-polymerizing the ink is less than the power of the ultraviolet radiation of said step of polymerizing the ink and the varnish.

In the polymerization step, the power of the radiation is greater in order to obtain homogenous drying and complete curing of the ink and of the varnish.

By way of example, the power of the ultraviolet radiation of said step of polymerizing the ink and the varnish is substantially equal to 16 W.

In comparison, the power of the ultraviolet radiation of the step of pre-polymerizing the ink is less than 2 W, and preferably between 0.05 and 0.10 W.

According to a second aspect, the present invention relates to an electronic chip card comprising on a surface a pattern printed by a printing method according to the invention.

According to the invention, the difference in thickness of the printed pattern on the surface of said card, between a highest point and a lowest point of said pattern, is less than 0.010 μm.

The texture of the printed surface of the card is thus made uniform, with very limited relief effects. Furthermore, the surface of the card with a coat of varnish has a more uniform shiny finish, both for the light portions and the dark portions of the printed pattern.

### BRIEF DESCRIPTION OF THE FIGURES

Other particular features and advantages of the invention will become more apparent from the non-limiting description which follows.

In the attached drawings, which are given as non-limiting examples:

FIG. 1 is an algorithm illustrating the steps of a printing method according to one embodiment of the invention;

FIG. 2 is a simplified diagram of an inkjet printing machine suitable for implementing the printing method according to the invention; and

FIG. 3, FIG. 4 and FIG. 5 schematically illustrate examples of electronic chip cards comprising on a surface a pattern printed by the printing method according to the invention.

### DETAILED DESCRIPTION OF THE INVENTION

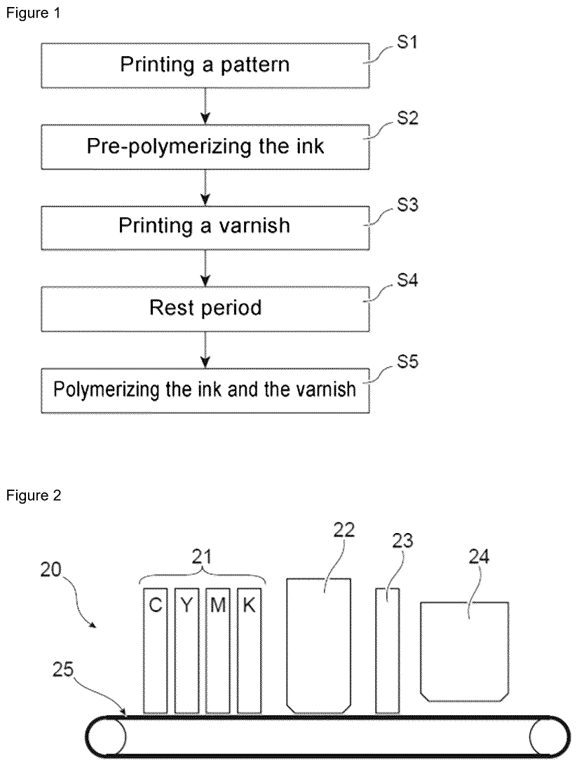

First of all, one embodiment of a method for inkjet printing a pattern on a surface of an electronic chip card will be described with reference to FIG. 1.

Throughout the remainder of the description, an electronic chip card is understood to mean any type of chip card, such as GSM (Global System for Mobile communications) cards, bank cards, access cards, etc. The present invention relates both to chip cards which use contacts or magnetic strips to communicate with card-reading terminals, and to those which communicate via radio frequency waves, referred to as “contactless” chip cards.

The printing method described below is particularly well suited for printing a pattern that is personalized depending on the holder and/or the provider of the card.

Inkjet printing makes it possible to print a personalized pattern (text, image, design) on the surface of the card.

Reference is thus made to DoD (abbreviation for Drop on Demand) printing for inkjet printing, based on a file of digital data which are configured depending on the personalized pattern to be printed.

The use of inkjet printing is well known and there is no need for it to be described in detail here.

In particular, it is implemented using a machine having printheads which allows E2E (“edge-to-edge”) printing, that is to say the printing extends up to the edges of the card without leaving white margins. This printing technique is also called borderless printing.

As illustrated in FIG. 1, the printing method first of all comprises a step of printing S1 by means of inkjet printheads to form a colour pattern on the surface of the card.

The colour pattern may comprise at least two, and generally multiple, distinct colour portions.

The portions of the pattern to be printed may be black and white with various levels of grey, or of colours of varying shades.

Referring to FIG. 2, an inkjet printing machine 20 is schematically illustrated with four printheads 21.

Each printhead 21 contains a set of very thin nozzles via which the ink is expelled. Each printhead 21 is connected to a tank of ink of a different colour. Each printhead 21 is furthermore heated to a temperature of the order of 60° C.

Typically, inkjet printing using CYMK printheads is used. This technology is based on spraying miniscule droplets of ink onto a support, here onto the surface of the card, in order to reproduce colour images and texts.

CYMK is the acronym for the four colours of ink used: Cyan, Yellow, Magenta and Key (for black). These inks are precisely mixed in order to create a large range or shades of colours.

The printheads 21 contain numerous micro-nozzles which project the ink droplets. Each nozzle is controlled individually in order to control the volume and the placement of the droplets, making it possible to reproduce shades and gradations of colour in a detailed and precise manner.

Preferably, the printheads 21 are controlled by a printing driver on the basis of a selected level value on a scale of levels of between 0 and 255. This scale of levels makes it possible to control the amount of ink that is deposited by each printhead.

Each value on this numerical scale from 0 to 255 represents a certain amount of ink projected per pixel.

The levels ranging from 0 to 255 represent a range of ink amounts. A value of 0 means that no ink is deposited (white), whereas a value of 255 means that a maximum amount of ink is applied (black or solid colour).

This printing driver makes it possible to precisely control the size and the density of the ink droplets deposited on the support, this being crucial in order to obtain precise image details and colours.

The step of printing an image S1 is thus controlled by software, which translates the digital information of the pattern to be printed into levels of ink to be applied, and by sending corresponding commands to each printhead via the printing driver.

In the embodiment described below, the setting on the numerical scale is carried out between 0 (0 drops) and 255 (4 drops), the amount of ink projected for each value from 0 to 255 varying linearly between 0 and 4 drops.

The printing method then preferably comprises a step of pre-polymerizing S2 the ink, by applying ultraviolet radiation to the colour pattern formed on the surface of the card.

This pre-polymerization step S2 is implemented to partially dry and/or solidify the ink immediately after it has been deposited on the surface of the card.

This method is also called “pinning” and makes it possible to stabilize the ink droplets, preventing their diffusion or their excessive mixing on the support, this possibly compromising the sharpness and the precision of the printed pattern.

As illustrated in FIG. 2, the inkjet printing machine 20 comprises an ultraviolet radiation light 22 for carrying out this pre-curing of the ink on the surface of the card.

The ultraviolet radiation light 22 is of low power or intensity, enough to lightly attach the ink but without polymerizing it or drying it completely.

In practice, the power of the ultraviolet radiation during the step of pre-polymerizing S2 the ink is less than 2 W, and preferably between 0.05 and 0.10 W.

The ultraviolet radiation light 22 is, for example, a light having a maximum power of 2 W, with numerical setting over a range of values between 0 (0 W) and 255 (2 W), allowing linear setting between 0 and 2 W.

The value of 10, corresponding to 20/255 W, i.e. 0.078 W, may thus be selected.

The exposure time is furthermore relatively short in order to avoid complete curing of the ink on the card. The pre-polymerization step does not last a very long time and allows the ink to dry owing to localized drying on the surface of the card.

In practice, the card is moved continuously under the ultraviolet radiation which is localized, over a very small width.

The pre-polymerization step S2 makes it possible to prevent the ink from spreading and the colours from mixing, in order to retain sharper edges of the printed pattern.

The printing method also comprises a step of printing S3 a varnish, by means of a printhead, on the surface of the card.

The step of printing a varnish S3 is implemented after the step of pre-polymerizing the ink S2.

As illustrated in FIG. 2, a varnish printhead 23, similar to the inkjet printheads 21, is used in the inkjet printing machine 20.

The varnish printhead 23 is also controlled by a printing driver in the same way as the inkjet printheads 21.

In practice, the varnish printhead 23 is controlled by a printing driver on the basis of a selected level value on a scale of levels of between 0 and 255 respectively corresponding to an amount of varnish deposited by the printhead 23 for each printed pixel.

As above, the selected value varies linearly between 0 drops (value 0) and 4 drops (value 255) deposited for each pixel of the printed pattern.

In practice, in the step of printing a varnish S3, a uniformly distributed amount is applied by the varnish printhead 23 to the surface of the card.

Thus, the same amount of varnish is projected for each pixel of the printed pattern on the card.

In practice, the selected value is at least equal to 155, and preferably greater than 175, for each pixel of the printed pattern.

This selection thus substantially corresponds to the projection of at least 2.5 drops of varnish per pixel.

This minimal amount of varnish allows the varnish to be distributed uniformly over the surface of the card and prevents the appearance of lines (or streakings) which correspond to a printing error, making the images or the texts of the pattern less sharp and homogenous.

In practice, the selected value may be between 175 and 255, corresponding to the projection of 2.5 to 4 drops of varnish per pixel.

This maximum threshold value of 255, corresponding to 4 drops of varnish, makes it possible to limit the total amount of varnish on the surface of the card, in order to limit the overlayer of varnish, and therefore the total thickness of the card after printing. The maximum threshold value also makes it possible to limit the extra production cost associated with the use of a varnish.

By way of example, the varnish used may be a varnish sold by the American company Entrust® for DoD printing.

Generally, a varnish which has a viscosity of between 1 and 5 cP (centipoises) is suitable for this step of printing a varnish S3.

The projected varnish makes it possible to compensate for the reliefs created during the inkjet printing of a pattern and to homogenize the shine of the printed surface.

Specifically, depending on the colours of the inkjet printed pattern, the finish of the printed surface is more or less dull (light colours) or shiny (dark colours).

Furthermore, since the hue of the printed colour depends on the amount of ink projected by inkjets, the amount of projected ink is greater for dark colours, which thus form a greater excess thickness on the surface of the card, than for light colours, which require a lesser amount of projected ink.

The projected varnish makes it possible to compensate for the differences in excess thicknesses between the light colours and the dark colours of the pattern produced by inkjet printing.

In order to achieve this homogenization on the surface of the card, the printing method comprises a step of implementing a rest period S4.

This rest period allows the varnish to spread over the surface of the card, at a speed that is dependent on its viscosity.

Typically, a varnish used in inkjet printing must have a viscosity that is low enough to ensure good fluidity and good passage through the printing nozzle 23.

Typically, the viscosity of the varnish used may be in a range ranging from 1 to 20 cP (centipoises) and may vary depending on the chemical composition of the varnish. Preferably, a varnish having a viscosity of between 1 and 5 cP is suitable for a rest period of less than 2 seconds.

Preferably, the rest period during the step of implementing a rest period S4 is at least equal to 0.5 seconds, and preferably greater than 0.8 seconds.

The minimum threshold value of 0.5 seconds allows the varnish to spread over the surface of the card and to fill the interstices which exist in the distinct printed colour portions of the pattern.

Preferably, in order not to slow down the production of the printing of the cards, this rest period is less than 2 seconds. In fact, extending the rest period does not have a notable effect on the uniformization and spreading of the varnish beyond a certain duration of the rest period and slows down the rate of production without any benefit in terms of homogenization of the varnish on the card.

Finally, the printing method comprises a step of polymerizing S5 the ink and the varnish by applying ultraviolet radiation to the surface of the card.

The polymerization step S5 is carried out by a high-power ultraviolet light 24, such as schematically shown in the printing machine of FIG. 2.

The power of the ultraviolet radiation of the high-power ultraviolet light 24 used in this step of polymerizing S5 the ink and the varnish is substantially equal to 16 W.

The power of the ultraviolet radiation must be enough to allow homogenous drying and total curing or polymerization of the ink and of the varnish printed on the surface of the card.

The use of ultraviolet radiation allows the inks and the varnish applied to the surface of the card to dry practically instantaneously. The inks thus dry by a process of photopolymerization when they are exposed to the ultraviolet light.

The polymerization step S5 allows good adhesion of the ink and of the varnish to the surface of the card and makes it possible to limit, when the latter is being used, scratches or alteration of the pattern through abrasion.

In particular, the power of the ultraviolet radiation of the step of polymerizing S5 the ink and the varnish is greater than that applied during the step of pre-polymerizing the ink.

The beam of the high-power ultraviolet light 24 is furthermore wide enough to cover the entire surface of the printed card and thus proceed to polymerize all the points of the surface of the card.

As illustrated in FIG. 2, the printing machine 20 may further comprise a moving belt 25 making it possible, during the implementation of the printing method such as described above, to move the electronic chip card to face various printheads 21, 23 and ultraviolet lights 22, 24 in a process for printing cards continuously.

The distance between the varnish printhead 23 and the high-power ultraviolet light 24 on the one hand, and the speed of movement of the moving belt 25 on the other hand, are determined in relation to one another so as to ensure the rest period of at least 0.5 s, and preferentially of 0.8 s, between the step of printing the varnish S3 and the polymerization step S5.

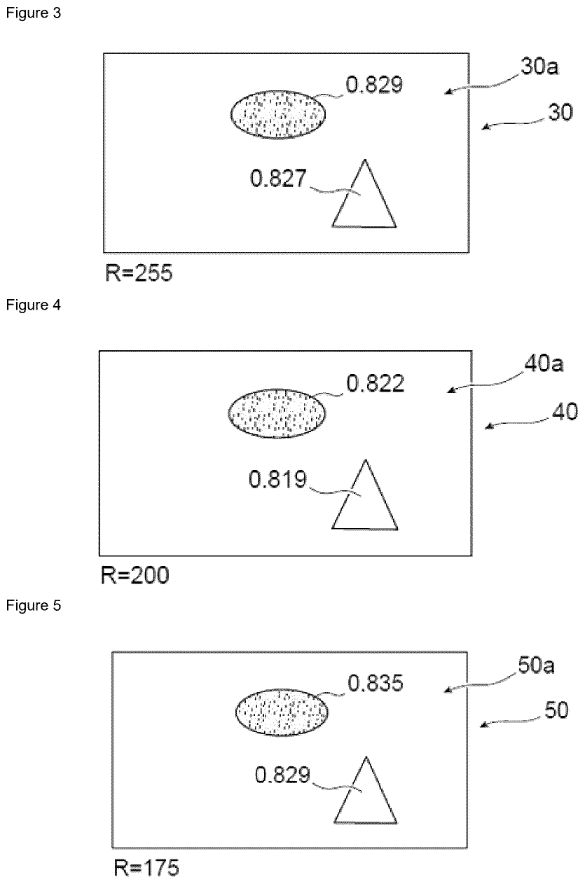

FIGS. 3 to 5 illustrate examples of electronic chip cards comprising on a surface a pattern printed by a printing method in accordance with the printing method described above.

In FIGS. 3 to 5, each card 30, 40, 50 comprises a pattern printed on its surface 30a, 40a, 50a.

Illustrated very schematically, and in a purely illustrative manner, is a pattern comprising an image in the shape of an ellipse, formed of points or pixels printed in dark or black colour, and an image in the shape of a triangle, formed of points or pixels printed in light colour.

Typically, after the step of inkjet printing such a pattern, the deviation in thickness between the points of the darkest portions and the points of the lightest portions of the printed pattern is at least 0.015 μm.

The deviation in thickness, in micrometres, is defined as the difference between the highest thickness formed by the ink deposited on the surface of the card, obtained for the darkest points of the printed pattern, and the lowest thickness formed by the ink deposited on the surface of the card, obtained for the lightest points of the printed pattern.

This deviation in thickness is generally of the order of 0.020 μm, sometimes possibly reaching 0.025 μm after the step of inkjet printing the pattern.

The printing method described above, with the printing of a varnish by means of a printhead and the polymerization of the ink and of the varnish after a rest period, makes it possible to make the thickness formed by the printed pattern on the surface of the card uniform, and to limit the deviation in thickness.

The deviation in thickness is thus less than 0.010 μm. The texture of the surface of the card and the shiny appearance are thus made uniform.

The deviation in thickness is all the smaller the greater the amount of varnish deposited by the printhead.

Illustrated, in a comparative manner in FIGS. 3 to 5, is thus a card 30, 40, 50 after the implementation of the printing method described above, wherein the amount of varnish in the step of printing varnish S3 varies between 175 and 255 (corresponding to a linear variation between about 2.5 and 4 drops of varnish per pixel).

The results are summarized below.

| | Setting of | | | |
|---|---|---|---|---|
| | the | Maximum | Minimum | Deviation in |
| | amount of | thickness | thickness | thickness |
| | varnish | (μm) | (μm) | (μm) |
| Card 30 | 255 | 0.829 | 0.827 | 0.002 |
| Card 40 | 200 | 0.822 | 0.819 | 0.003 |
| Card 50 | 175 | 0.835 | 0.829 | 0.006 |

Thus, the deviation in thickness, that is to say the difference in thickness of the printed pattern on the surface of each card 30, 40, 50, between a highest point and a lowest point of the pattern, is less than 0.010 μm.

Of course, the exemplary embodiments given above are in no way limiting, in particular with regard to exemplary dimensions or materials.

In particular, the printing method might not comprise a pre-polymerization step.

Furthermore, each electronic chip card may comprise a printing of a pattern on its two opposite faces.

1. A method for inkjet printing a pattern on a surface of an electronic chip card, comprising the following steps:
printing by means of inkjet printheads to form a colour pattern on the surface of the card;
printing a varnish, by means of a printhead, on said surface of the card;
implementing a rest period; and
polymerizing the ink and the varnish by applying ultraviolet radiation to the surface of the card.

2. The printing method according to claim 1, wherein the colour pattern comprises at least two distinct colour portions.

3. The printing method according to claim 1, wherein the rest period is at least equal to 0.5 seconds.

4. The printing method according to claim 1, wherein in the step of printing a varnish, a uniformly distributed amount is applied by the printhead to the surface of the card.

5. The printing method according to claim 4, wherein in the step of printing a varnish, the printhead is controlled by a printing driver on the basis of a selected level value on a scale of levels of between 0 and 255 respectively corresponding to an amount of varnish deposited by said printhead for each printed pixel, the amount of varnish deposited varying linearly between 0 drops at level 0 and 4 drops at level 255 and the selected value being at least equal to 155.

6. The printing method according to claim 1, wherein it further comprises a step of pre-polymerizing the ink before said step of printing a varnish, by applying ultraviolet radiation to the colour pattern formed on the surface of the card.

7. The printing method according to claim 6, wherein the power of the ultraviolet radiation of the step of pre-polymerizing the ink is less than the power of the ultraviolet radiation of said step of polymerizing the ink and the varnish.

8. The printing method according to claim 7, wherein the power of the ultraviolet radiation of the step of pre-polymerizing the ink is less than 2 W.

9. The printing method according to claim 1, wherein the power of the ultraviolet radiation of said step of polymerizing the ink and the varnish is substantially equal to 16 W.

10. An electronic chip card comprising on a surface a pattern printed by a printing method according to claim 1, wherein the difference in thickness of the printed pattern on the surface of said card, between a highest point and a lowest point of said pattern, is less than 0.010 μm.

11. The printing method according to claim 1, wherein the rest period is greater than 0.8 seconds.

12. The printing method according to claim 4, wherein in the step of printing a varnish, the printhead is controlled by a printing driver on the basis of a selected level value on a scale of levels of between 0 and 255 respectively corresponding to an amount of varnish deposited by said printhead for each printed pixel, the amount of varnish deposited varying linearly between 0 drops at level 0 and 4 drops at level 255 and the selected value being greater than 175.

13. The printing method according to claim 7, wherein the power of the ultraviolet radiation of the step of pre-polymerizing the ink is between 0.05 and 0.10.
